(19) United States
(12) Patent Application Publication
(10) Pub. No.: US 2026/0081369 A1
(43) Pub. Date: Mar. 19, 2026

(54) Systems and Methods for Electrical Earthing

(71) Applicant: Grounding Technology Group, Inc., Chattanooga, TN (US)

(72) Inventors: Thomas Evan LaBarge, Chattanooga, TN (US); John Louis Broccoli, Copperhill, TN (US); John H. Belk, Blue Ridge, GA (US); Mark Johnson, Blue Ridge, GA (US)

(21) Appl. No.: 19/274,464

(22) Filed: Jul. 18, 2025

Related U.S. Application Data
(60) Provisional application No. 63/673,167, filed on Jul. 18, 2024.

(51) Int. Cl. H01R 4/66; H01R 4/62

(52) U.S. Cl. CPC H01R 4/66; H01R 4/62

(57) ABSTRACT

A system and method are disclosed for an electrical earthing or grounding system to protect electrical systems and structures. Such systems and structures are efficient at dissipating broadband energy. An improved grounding electrode system is described having improved electrode configurations resulting in improved dissipation of fault current into native soil while simplifying installation significantly.

This disclosure relates to electrical grounding systems. More specifically, this disclosure relates to improvements in ground electrode configurations, as well as in earthing mixes and related components and subcomponents for systems employing the ground electrodes as described. The disclosure relates to electrical grounding systems having improved ground electrodes and related components that can substantially reduce installation time and cost while concurrently improving charge dissipation.

### BACKGROUND

Various electrical grounding techniques are utilized throughout the world for the prevention of electrical damage to buildings, equipment, and personnel. Such grounding techniques find numerous applications in such diversified areas as power and telecommunication systems, vehicles, electronic equipment, fuel storage tanks, industrial installations, commercial and residential buildings as well as buried equipment such as pipelines. A “ground” is an electrical connection between a circuit or equipment and the earth or a large conducting body that serves in place of the earth. “Grounding” or “earthing” an electrical system is installing a ground in the electrical system and is part of a normal electrical circuit.

The safe return of errant electrical current (also called “fault current”) to the earth without damage to life or devices concerns businesses, utilities, and homeowners and to some degree can be handled by a normal grounding system.

Fault currents can be created in myriad ways including by a lightning strike, equipment failures, a short in a circuit path from a tree branch, release of static charge build-up, or insulation failure and they can occur over any time scale including the first current to arrive called sub-transient current, transient current, and persistent current. When a grounding system fails to dissipate enough of a fault's energy, valuable assets can be destroyed and people can be injured or killed. In the United States, the National Electric Code (NEC) requires a protective ground to prevent voltage or charge build-up from a lightning strike, a short in a circuit path, or insulation failure that would otherwise cause electrical shock, injury, or death. In an industrial setting, the absence of a very low-resistance grounding path can cause a build-up of static electricity which in turn can introduce noise into communication and transmission circuits and can present a danger when handling flammable materials.

Grounds protect electrical equipment or systems from reaching excessive voltage by providing an alternate path for current to travel (other than through an electrical circuit in the equipment). Grounding is also valuable for preventing electric shock hazards. A neutral wire can connect electrical equipment to a ground system of a structure to prevent development of large voltage differences between the neutral line and a ground line leading from the ground pin of a plug to the chassis of the equipment.

Ground rods, also known as ground electrodes, are meant to balance the cost of installation (often simply hammered into the ground) while interacting with soil deep enough to provide a chance of surrounding the device with moisture. In terrain where the soil depth is much less than the ground rod length, horizontal grounding plates are sometimes used. Additional grounding electrode structures including concrete or cement filled with conductive powder or metal including rebar encased in a building foundation; both structure types can act as core electrodes for a grounding system.

FIG. 1 illustrates a simplified ground rod design which has been the standard for grounding systems in the art for decades. As seen in this simplified example of the ground rod design, a metal ground rod 102 is placed in local or native soil 103 and attached to a fault current source 101. In this simplified example, electrical charge would enter the ground rod 102 from a fault current source 101 via a conducting wire 105. The hope is that as much as possible of the arriving electrical charge would dissipate from the ground rod in all directions generally perpendicular to the surface of the ground rod 102 at that location. More complex examples of this system might include the conductive cement as described above. However, these basic measures can be insufficient to protect people or property during large current faults or faults including those consisting of frequencies outside the normal frequency range of the installation or as the local soil varies in electrical conductivity or moisture content. Some of the current in older systems can reflect the electrical energy back towards the source. As shown in FIG. 2, while some of the incoming current flow 110 will move along the ground rod 102 towards the ground rod tip 106, and then dissipate 120 into the local or native soil 103. However, a significant amount of the current becomes reflective current 130, traveling back up the ground rod 102 towards the fault current source 101 (not shown) via the metal wire conductor 105.

In Applicants prior work, improved grounding has been accomplished using both improved electrode structures as well as improved dissipations mediums. In Applicants first patent, U.S. Pat. No. 10,236,598, which is incorporated herein by reference, a combination of materials were used to more effectively move fault current at both high and low frequencies into the grounding electrode system. And, as described in Applicants second patent U.S. Patent No., 11,329,406, also incorporated herein by reference in its entirety, using improved materials to move electrical current form the grounding electrode to the native soil can result in less current traveling back from the ground system back into any equipment connected to the grounding electrode.

Based on these prior developments, Applicant has discovered a number of additional improvements in electrical grounding methods and systems that are described herein. Particularly, improved grounding electrodes are described.

More particularly, improved methods of installing these grounding electrodes are described. Further, improved methods of using the described electrodes to dissipate fault current across a wider range of frequencies are described. Still further improved electrode configurations having improved conductive earthing material configurations are described. The electrodes and configurations as described result in improved dissipation of fault current into native soil. Finally, improved multi-electrode products and mobile grounding options are also described.

### SUMMARY

It is to be understood that this summary is not an extensive overview of the disclosure. This summary is exemplary and not restrictive and it is intended to neither identify key or critical elements of the disclosure nor delineate the scope thereof. The sole purpose of this summary is to explain and exemplify certain concepts of the disclosure as an introduction to the following complete and extensive detailed description.

In an aspect, the invention is directed at an earthing system that includes an electrode for placement in a hole in the ground wherein the electrode comprises two parallel surfaces; at least one conductive earthing mix in contact with a carbon fiber material wherein the conductive earthing mix and carbon fiber material are between the two parallel surface of the electrode; and at least one impedance transitioning earthing mix contacting the at least one conductive earthing mix in the hole in the ground.

In an aspect, the invention is directed at a method of installing an earthing system, comprising producing a hole in native soil of the ground; placing an electrode comprising two parallel surfaces within the hole; placing a conductive earthing mix in contact with a carbon fiber material between the two parallel surface of the electrode; and placing at least one impedance transitioning earthing mix between the at least one conductive earthing mix and the native soil of the ground.

The present disclosure relates to a system, apparatus, and method for an energy-dissipating electrical grounding system.

### DESCRIPTION

The features and components of the following figures are illustrated to emphasize the general principles of the present disclosure. Corresponding features and components throughout the figures can be designated by matching reference characters for the sake of consistency and clarity.

### BRIEF DESCRIPTION OF THE DRAWINGS

FIG. 1 illustrates a typical grounding system known in the art.

FIG. 2 illustrates the flow of electrical energy within the grounding system of FIG. 1

FIG. 3 illustrates a photograph of a core electrode according to one embodiment of the invention.

FIG. 4 illustrates a photograph of a core electrode system after being buried in the ground.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

In the following discussion and in the claims, the terms “including,” “comprising,” and “is” are used in an open-ended fashion, and thus should be interpreted to mean “including, but not limited to.”

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

### DEFINITIONS

Shielding: Electromagnetic shielding is the practice of reducing the electromagnetic field in a space by blocking the field with barriers made of conductive or magnetic materials.
Grounding or Earthing: In an electrical installation, an earthing system (UK) or grounding system (US) connects specific parts of that installation with the Earth's conductive surface for safety and functional purposes. The point of reference is the Earth's conductive surface.
Electrode: In this context, an electrode is a solid conductor whether it is metal or not and regardless of its shape. It can collect or emit or transfer electrical charge or current.
Current source: A current source in this context is any source of electrical current whether it is that from normal operation of an electrical device or system, static build-up, or of that created during an electrical fault or even a lightning event. A spark or an electrical short would also serve as a fault current source.
Earthing mix: Earthing mixes are designed to improve the transfer of electrical energy (current) from a grounding electrode into the local soil. An earthing mix is either added to local soil or wholly created to replace local soil adjacent to a grounding electrode with the aim of improving the ability of the grounding electrode to dissipate electrical energy into the earth. For some applications, the goal is to just meet local electrical codes which in the USA rely on measurement of “resistance to ground”for normal usage.
Local or native soil is the soil found on the installation site.
Backfill is local or native soil from the job site, which can, but does not have to, include modified soil.
Modified soil is soil which has been modified in some way. It can be based on local soil, backfill, or it can be trucked in.
Conductive earthing mix: Conductive earthing mixes are mixtures which have been designed to increase the electrical energy (current) which can be stored in its volume or transferred to another material on its way to the local soil. It is generally a solid compound formed from minerals and other durable materials such that its electrical conductivity remains stable and is similar to brackish water.
Impedance Transitioning mix: Impedance transitioning earthing mixes are mixtures which have been designed to reduce mismatch of the electrical properties at one or both of its interfaces with soil or other materials including earthing mixes and electrode elements. It is generally an electrically conductive blend of materials, primarily organic, that acts in concert with the Native Soils, mimicking the rise of fall of soil conductivity with changing moisture content.
Consolidation mix: A clay-based slurry which will bond to solid clay masses and fill the interstices between them.
Capping mix: A layer of particulates which consolidates into a unit, allowing water to move downward through it, while resisting the flow of vapor from below.
Diatomaceous earth: A sedimentary silicate mineral formed by petrifying the shells of diatoms (flat marine micro-organisms) leaving very fine, sharp edged porous particles.
Electrical resistance: a measure of the difficulty to pass an electric current through a conductor. It can be from either surface of volumetric resistance.
“Elongated particles”have dimensions with an aspect ratio of at least 3.
Dispersion: In this context, dispersion refers to dispersing particles of one material into another material or mix. The quantity of the newly introduced material can affect chemical, electrical, or mechanical properties of the mix and the uniformity can affect the efficiency with which these property changes occur.
Percolation in electrical systems refers to the behavior of electrical charges when they jump from one particle to another in seemingly random fashion once the distance between them is sufficiently small to allow the charge to transfer. Mixtures of materials can become conductors once there is a pathway which can be used by charge with sufficient voltage.
Semiconductors are materials which have an electrical conductivity value falling between that of a conductor, such as metallic copper, and an insulator, such as glass. Its resistance falls as its temperature rises; metals are the opposite.

Its conducting properties may be altered in useful ways by introducing impurities (“doping”) into the crystal structure.
Coefficient of Linear Extensibility (COLE): The linear contraction of an unconfined mass of soil when dried from a wet state to a dry state.
Organic: Materials containing Carbon chain molecules such as plant matter, fossil fuels, and peat.

Electromagnetic elongated conductive particles respond to a varying magnetic field by rotating or vibrating unless restrained in which case the equivalent energy is converted to heat.
Deflocculating agent: An ionized salt or organic material, usually in aqueous solution, that changes the surface charge on small particles such that they repel one another, lowering the viscosity of a suspension of those particles.

Barrier materials in this context act to retard or eliminate fluid passage, generally through a surface or interface.

Bandwidth is a measure of the frequency range of a system.
“Nano” means small but has been adopted to mean “sub-micron” and, as “nanometer”, means 10⁻¹² meter. As applied to nanomaterials, nanoparticles, and nanostructures, it relates to materials or structures which are in the general range between 1 nanometer and 100 nanometers but often includes agglomerations of nanomaterials which exceed this top limit.
Electrically lossy medium; anything in an electrical or electronic circuit or power system that dissipates part of the energy in play by unwanted effects, including energy heating of resistive components, the effect of parasitic elements (resistance, capacitance, and inductance), skin effect, losses in the windings and cores of transformers due to resistive heating and magnetic losses caused by eddy currents, hysteresis, unwanted radiation, dielectric loss, corona discharge, and other effects.

As discussed in U.S. Pat. No. 11,329,406, (hereinafter “the '406 patent”) the instant Applicant has developed an improved grounding system that overcomes issues with traditional grounding systems including moisture retention, electrode spacing, impedance mismatch, electrode efficiency and frequency bandwidth. This prior electrode system described in the '406 patent while performing very well for electrical grounding has certain drawback associated with installation.

Disclosed is an electrical grounding system having an improved electrode configuration and an improved earthing mix configuration making them simpler and much cheaper and easier to install while providing improved current distribution. Like the system described in the '406 patent, the instant grounding system achieves results superior to those of conventional grounding systems while reducing operational costs for users, especially via reduced annual operating losses, lowering maintenance demands, and reducing customer downtime. These and other benefits are attendant to the electrical grounding system disclosed herein.

It is a principal objective of the present invention to provide a protective electrical earthing system including an electrode efficiently transfers electrical charge into and through surrounding earthing mixes which cooperatively dissipate the electrical charge while permitting long-term operation of the entire system as the market adapts to increased communications traffic and enlarges the frequency allocations available for such systems.

It is a further objective of the present invention to provide a system for electrical grounding as aforesaid which exhibits the following attributes: (1) a level of electrical conductivity throughout supporting efficient electrical dissipation; (2) a gradient of electrical properties at material interfaces supporting efficient electrical dissipation generally towards and into local soil; (3) efficient electrical energy dissipation over a broad range of current densities and frequencies; (4) retention of sufficient water to maintain a large volume of stable conductive material during changing seasons and weather conditions; (5) further improved costs of manufacture and installation; and (6) minimal adverse environmental impact.

With a view to achieving these objectives and overcoming the installation limitations associated with the grounding system described in the '406 patent, the present invention provides a system utilizing earthing mixes and electrode structures that enable design of a wider range of highly efficient and broadband-capable grounding systems consistent with many differing installation types and locations with varying functionality requirements.

A typical electrical protection system, including grounding and shielding systems must provide for electrical current to be dissipated all day every day at low energy levels and usually at frequencies near 50 Hz or 60 Hz. It is common to use electrical resistance values to determine compliance with local electrical codes.

Electrical impedance extends the concept of direct current (DC) electrical resistance to alternating current (AC) and allows further understanding of electrical properties at frequencies well beyond DC or 60 Hz. The electrode of an electrical grounding system, be it a copper wire, a copper-bonded steel rod, a metal plate, a mass of concrete or cement or polymer that has been made somewhat conductive, or any other electrically conductive structure, must receive electrical current from the current source via an incoming bus bar, wire, or cable, then carry the current from the current source into the electrode structure which must in turn dissipates the electrical energy into the soil. The electrical energy can be dissipated as radio frequencies, electrical current, or heat. It is also possible that sound or motion can be generated which will also result in energy dissipation. Dissipation as radio frequencies is dependent on the antenna properties of the core electrode and its surrounding materials.

The electrical energy will generally travel from higher conductivity materials into lower electrical conductivity materials until it enters the lowest electrical conductivity material regardless of routing of the path. By providing a system with multiple interfaces between different materials with various conductivity levels (which can be measured in a number of ways, including, but not limited to, electrical resistance level, electrical reactance level, electrical capacitance level, or electrical impedance level), a larger amount of electrical energy dissipation occurs.

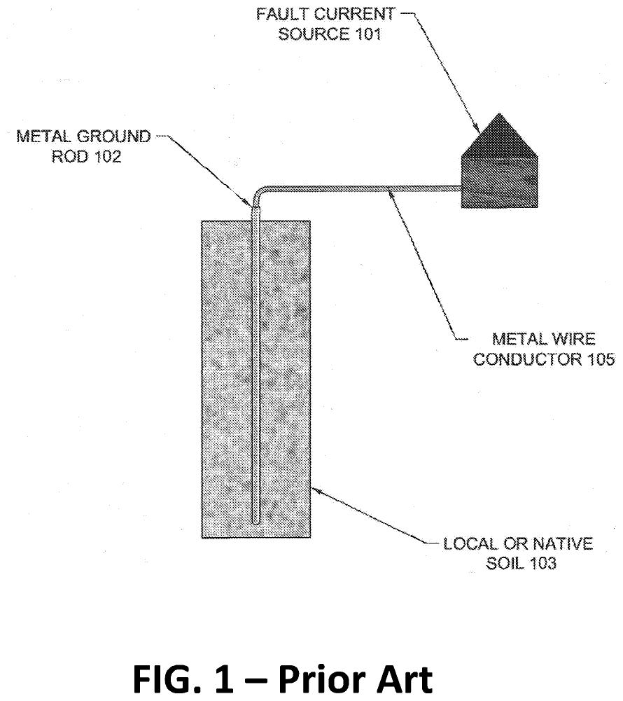

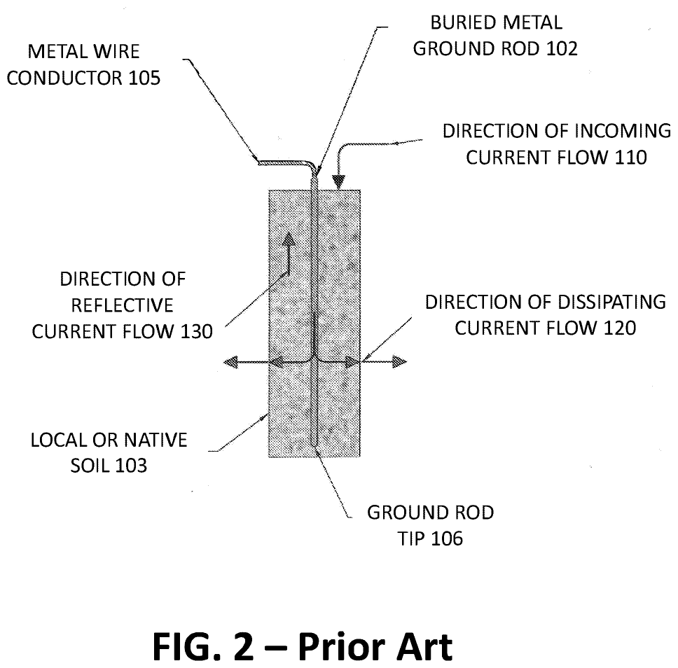

Of course, some of the electrical energy will reflect from interfaces between materials due to impedance mismatches resulting from material property changes and route back into the incoming wire and proceed towards the current source. At very high energies, including those occurring during a lightning event, an electromagnetic field will somewhat reduce the development of electrical pathways strongly diverging from the present course of the electrical energy. The electrode of the electrical grounding system is generally buried in the local soil, which results in a mismatch between the core electrode's electrical properties and that of the local soil (see FIG. 1). The mismatch results in some current being redirected towards its source (See FIG. 2). Much of the rest of the arriving energy is dissipated into the soil.

The reflected energy from an interface between two materials with an impedance mismatch travels away from that interface in the direction from which it came, generally towards the electrical system the grounding system is meant to protect. Fortunately, each layer of material, be it a wire, a grounding system substructure, or an earthing mix, is not a perfect conductor and will result in a new opportunity to dissipate energy along that path. In addition, each material interface with an impedance mismatch along this path also offers an opportunity to reflect some of this previously reflected energy back towards the local soil. It can be a complicated process to manage.

A system as described including improvements to the grounding system's core electrode structure, which can have different sizes and ultimate configurations that may enlarge the conductive volume providing for additional charge emission points (and edges). Furthermore certain improvements in earthing mixes and earthing mix configurations are described.

The electrical protection earthing system of the present invention is configured to utilize a variety of components including different materials in to order to increase energy dissipation more effectively across a broad range of frequencies while greatly reducing maintenance. The electrical protective earthing system includes an electrode and an earthing mix. The core electrode can include a number of different materials. Similarly, the earthing mix can include multiple mixes with various purposes. In some aspects, the earthing mixes can include a conductive earthing mix that is configured to be placed adjacent to the electrode when the electrode is placed within the native soil. In addition, the earthing mixes can include an impedance transitioning earthing mix as well. The impedance transitioning earthing mix can be placed between the conductive earthing mix and the native soil within the ground. Additional earthing mixes can be included. Further, the electrode can be connected to a current fault source to form an electrical grounding system. In some aspects, the electrical protection earthing system can operate as a shielding system when the electrode is not connected to a fault current source. In some aspects, various materials, including clays and elongated particles, can be used to help retain water. These and other aspects of the electrical protection earthing system are discussed in detail below.

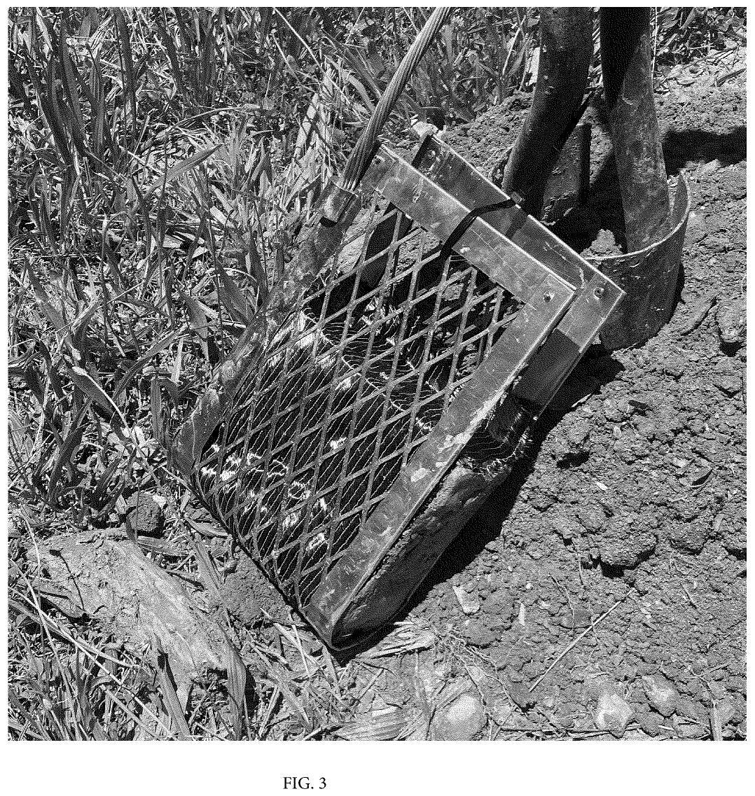

The core electrode as described, includes an improved structure making it as effective as the cylindrical electrodes described in the '406 patent, but substantially easier to install. The core electrode of the system as described herein may be porous or non-porous. In one embodiment, the electrode can have a configuration as seen in the photograph of FIG. 3. In the embodiment seen in FIG. 3, the electrode can be formed of a porous electrically conductive material, such as copper. The electrode is formed with two parallel surfaces, and in the embodiment shown the surfaces are connected via a rounded bottom. In another embodiment, the parallel plates may be attached via one or more connection means without a contiguous bottom. As seen in FIG. 3, the electrode further includes a cable for connecting the grounding system to the fault current source. The embodiment as seen in FIG. 3 includes a conductive earthing mix surrounded by a carbon fiber fabric that is oriented between the two parallel surfaces of the electrode. While the surfaces are described as parallel, they may in fact, be at any angle that would still allow them to reasonably contain the conductive earthing mix and carbon fiber fabric. Likewise the conductive earthing mix could take on any shape, as appropriate so long as it maintains contact with the core electrode.

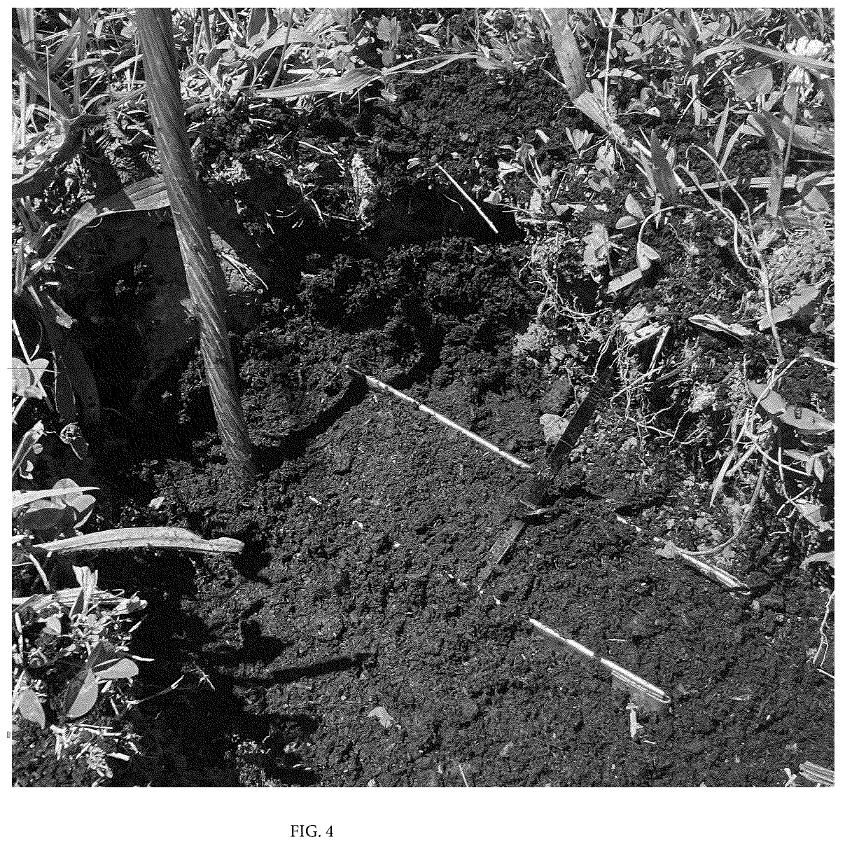

During installation, a hole is dug in the native soil and the electrode is buried. The conductive earthing mix, in the embodiment shown, is surrounded by carbon fiber fabric and placed between the parallel surfaces of the electrode. In one embodiment, the electrode may be placed into the hole and then the conductive earthing mix and carbon fiber fabric are added between the surfaces. In another embodiment, the conductive earthing mix and carbon fiber fabric are loaded to the electrode and the electrode is connected prior to placement of the electrode in the hole. In either embodiment impedance transitioning earthing mix is placed between the at least one conductive earthing mix and the native soil. As seen in FIG. 4, which shows a buried electrode system, native soil may be used to cover the electrode surface while the copper cable extends upward for creating the connection between the current source and the buried electrode.

Various electrically conductive materials are used for the electrode and practical needs including malleability, drapeability, formability, corrosion properties, and magnetic properties. Corrosion drives many choices as many metals, while electrically conductive, require replacement after several years due to corrosion.

Materials include, but are not limited to, copper, steel, molybdenum, carbon fiber (for example, PAN-based fibers for higher electrical conductivity and pitch-based fibers for lower electrical conductivity), and conductive composites of carbon fiber or other conductive material, e.g., electrically conductive particles including carbon powder or silicon carbide and elongated electrically conductive particles including chopped metal wires or carbon fibers or milled carbon fibers.

Further, the electrodes of the described earthing system can generally be buried in any orientation: the electrode can be placed in a., including, vertical or horizontal orientation, and any angle in between. In addition, the electrode can be placed at any depth in the local soil in a hole or pit or in a trench with rocky terrain or frost line considerations sometimes driving the decision as to depth and orientation. In one embodiment, the electrode is oriented vertically within the hole making it easier to line the hole with the impedance transitioning earthing mix.

Earthing mixes in general increase the electrical conductivity of the region around the electrode. Their primary purpose is to improve the dissipation of electrical energy into the surrounding soil but their contact with the electrode brings additional considerations. The earthing mixes can be designed to reduce corrosion of the metal conductors via addition of chemicals containing the at-risk metals (e.g., copper sulfate added to systems made with copper), addition of sacrificial anodes, avoiding conductive materials which corrode wherever possible, and avoiding dissimilar conductive materials as much as possible. The earthing mixes can be designed to manage local energy storage or manage electrical energy pathways to the local soil. They can be filled with conductive material or chemicals or ions to carry electrical charge. They can be filled with thermally conductive materials or thermal energy storage materials. They can also be designed to retain water through strong attraction to water molecules or reducing the occurrence of micro-cracks which provide moisture with a pathway to escape. They can also be designed to reduce occurrence of burrowing insects.

The earthing mixes and their interfaces play important roles in determining the amount of current that is reflected at that interface back out the incoming current wire metal conductor 105 towards the fault current source 101. The interface between porous or non-porous surfaces of the electrode and the conductive earthing mix will preferentially provide for electrical current to cross the interface more efficiently than the copper-to-local soil interface.

The conductive earthing mix is designed to conduct and store electrical energy during usage. The conducting earthing mix is configured to have electrical properties that better match the impedance values at the interface of the electrode and conductive earthing mix and the interface between the conductive earthing mix and the impedance transitioning earthing mix/composition, generally about half way between the effective values of the other materials at those interfaces, whether the interfaces are as described and whether or not the materials used include metal or non-metal conductors. If the electrical impedance, electrical conductivity, or electrical resistance of conductive earthing mix lies between that of the other two materials meeting at its interfaces, the efficiency of the electrical protective earthing system will be higher based on reduced back reflections of electrical energy.

In an aspect, the impedance transitioning earthing mix/composition can include more than one layer. The impedance transitioning earthing mixes can be concentric or wrapped for use with cables or rods or otherwise layered for use with plates or cables or rods. Regardless of the form, the impedance transitioning earthing mixes are configured to have better electrical properties at their interfaces than the electrode/native soil interface and the conductive earthing mix/native soil interface. Optimally, any sub-layers in the impedance transitioning earthing composition would gradually change the overall impedance transitioning layer's impedance to better match the interfaces at both outer surfaces of the impedance transitioning earthing composition's layer(s).

In an aspect, the conductive earthing mix can include a clay selected from the group of Montmorilinite, Bentonite, Illite, Smectite and Attapulgite and blends thereof. In such aspects, the clay is present in the conductive earthing mix in a range from and including 50% by weight to and including 99% by weight. In another aspect, the conductive earthing mix can include a plurality of elongated conductive particles (ECPs). In an aspect, each ECP ranges from one nanometer to three centimeters in length and has an aspect ratio of at least three. The ECPs are made of materials including, but not limited to, carbon fiber cuttings, nickel-plated polymer fibers, gold, copper-sulfate treated copper, boron fibers, conductive polymer fibers, carbon mesh, chopped metal wires including 8 micron steel fibers, other chopped metals including magnetic shielding materials like MuMETAL®, stainless steel fibers, nickel nanostrands, carbon nanotubes, electromagnetic elongated conductive particles, and semiconductors, and blends thereof. When present in the conductive earthing mix, the ECPs range from and including 0.05% by weight to and including 8% by weight. In an aspect, the conductive earthing mix includes a metal salt. The metal salt includes, but is not limited to, magnesium sulfate, calcium sulfate, copper sulfate, and calcium carbonate, and blends thereof. The metal salt is present in the composition from and including 1% by weight to and including 50% by weight. In some aspects, the conductive earthing mix includes electromagnetic elongated conductive particles (EECPs) that make up a subset of the ECPs. The EECPs are comprised of a material including, but not limited to, nickel, iron, carbon nanotubes, cobalt, aluminum, uranium, platinum, copper, brass, lead, ferrite, hematite, and blends thereof.

In an aspect, the impedance transitioning earthing composition is a blend of fibrous organic compounds, including, but not limited to, peat, rice hulls, peanut hulls, cellulose, and similar fibrous mixtures. The organic compound, when present, can make up 50% to 99% by weight of the dry weight of the impedance transitioning earthing mix. In some instances, the impedance transitioning earthing mix can include a metal salt. The metal salt can include bentonite, which can make up to 25% by weight of the impedance transitioning earthing mix. When other metal salts, including, but not limited to, magnesium sulfate, calcium sulfate, calcium carbonate, and copper sulfate, can make up 40% by weight. In some aspects, the impedance transitioning earthing mix includes elongated conductive particles (ECPs), making up between 0.1% and 10% by weight. The ECPs are made of materials including, but not limited to, carbon fiber cuttings, nickel-plated polymer fibers, gold, copper-sulfate treated copper, boron fibers, conductive polymer fibers, carbon mesh, chopped metal wires, nickel nanostrands, carbon nanotubes, and semiconductors, and blends thereof. In another aspect, the impedance transitioning earthing mix can include all of the components discussed above, but with the ECPs with non-electrically conductive particles to allow fluid and ion flow in the layer closest to the local soil without appreciably increasing that layer's electrical conductivity.

In another aspect, the earthing mixes include a consolidation mix/consolidation slurry. The consolidation mix includes comprises a clay selected from the group of Montmorillonite, Bentonite, Illite, Smectite and Attapulgite and blends thereof. The clay is present in the consolidation mix in a range from and including 1% by weight to and including 40% by weight. In an aspect, the consolidation mix includes a plurality of electrically conductive macro-, micro-, and nano-scale conductive particles 0.05% by weight to and including 5% by weight. The conductive particles can be comprised of materials including, but not limited to, gold, nickel, copper (mixed with graphene or otherwise treated to restrict corrosion), allotropes of carbon (including graphite, carbon black, carbon nanotubes, reduced graphene oxide, and graphene), allotropes of boron. In an aspect, the consolidation mix includes elongated conductive particles (ECPs), with each ECP ranging from one nanometer to three centimeters in length and having an aspect ratio of at least three. The ECPs are made from materials including, but not limited to, carbon fiber cuttings, nickel-plated polymer fibers, gold, copper-sulfate treated or graphene coated copper, boron fibers, conductive polymer fibers, carbon mesh, chopped metal wires, nickel nanostrands, carbon nanotubes, and semiconductors, and blends thereof. The ECPs are present in the composition in a range from and including 0.5% by weight to and including 5% by weight. In an aspect, the consolidation mix includes a metal salt selected from the group of magnesium sulfate, calcium sulfate, copper sulfate, and calcium carbonate, both hydrated and anhydrous, and blends thereof. The metal salt can be present in the composition from and including 10% by weight to and including 40% by weight. In an aspect, the consolidation mix can include a kaolinite-based clay mineral in a range from and including 0.5% by weight to and including 90% by weight, which increases the water retention of the system.

The '406 patent which is incorporated herein by reference describes a variety of multi-electrode configurations and manners of installation of such multi-electrode systems. The improved core electrode configuration as described herein can be used in the various multi-electrode configurations noted in the '406 patent while being cheaper and easier to install. Each electrode installations is much simpler and overall system installations and connection would generally follow as described in the '406 patent.

Finally, in one embodiment, the core electrode as described by be sized for different electrical applications. A longer/larger version, for example 30 to 50 inches, e.g., 36 inches, of the described electrode can be used for large installation requirements, while a smaller version of the electrode, for example, a 12 inch version, may be used for smaller installation of mobile applications such as temporary grounding associated with mobile telecommunications or mobile emergency services needs.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure

We claim:

1. An earthing system comprising:
a. an electrode for placement in a hole in the ground wherein the electrode comprises two parallel surfaces;
b. at least one conductive earthing mix in contact with a carbon fiber material wherein the conductive earthing mix and carbon fiber material are between the two parallel surface of the electrode; and
c. at least one impedance transitioning earthing mix contacting the at least one conductive earthing mix in the hole in the ground.

2. The system of claim 1, wherein the electrode is in communication with a current source.

3. The system of claim 1, wherein the electrode comprises a plurality of electrically conductive materials within different frequency bands.

4. The system of claim 3, wherein the plurality of electrically conductive materials further comprises a first conductive material comprising copper and a second conductive material comprising nickel or iron.

5. The system of claim 1, wherein the at least one conductive earthing mix or the at least one impedance transitioning earthing mix comprises a clay having moisture retaining properties.

6. The system of claim 1, wherein the at least one conductive earthing mix and the at least one impedance transitioning earthing mix further comprises a plurality of conductive particles.

7. The system of claim 6, wherein the plurality of conductive particles are elongated.

8. The system of claim 7, further comprising non-conductive elongated particles.

9. The system of claim 1, wherein the impedance transitioning earthing mix further comprises an organic base composition.

10. The system of claim 1, wherein the at least one impedance transitioning earthing mix further comprises a plurality of impedance transitioning earthing mixes, wherein each of the plurality of impedance transitioning earthing mixes has a unique electrical conductivity level, wherein the plurality of the impedance transitioning earthing mixes are located between the at least one conductive earthing mix in the hole in the ground and native soil of the ground in highest to lowest electrical conductivity levels from the at least one conductive earthing mix to the native soil of the ground.

11. A method of installing an earthing system, comprising:
a. producing a hole in native soil of the ground;
b. placing an electrode comprising two parallel surfaces within the hole;
c. placing a conductive earthing mix in contact with a carbon fiber material between the two parallel surface of the electrode; and
d. placing at least one impedance transitioning earthing mix between the at least one conductive earthing mix and the native soil of the ground.

12. The method of claim 11, wherein the conductive earthing mix and carbon fiber material are placed between the surfaces of the electrode prior to the electrode being placed into the hole in the ground.

13. The method of claim 11, wherein the at least one conductive earthing mix or the at least one impedance transitioning earthing mix further comprises a plurality of conductive particles and a plurality of elongated particles.

14. The method of claim 11, wherein placing the at least one impedance transitioning earthing mix between the at least one conductive earthing mix and the native soil further comprises:
a. providing a plurality of impedance transitioning earthing mixes, wherein each of the plurality of impedance transitioning earthing mixes has a unique conductivity level; and
b. placing the plurality of the impedance transitioning earthing mixes between the at least one conductive earthing mix in the hole in the ground and native soil of the ground in highest to lowest electrical conductivity levels from the at least one conductive earthing mix to the native soil of the ground.
